(19) United States
(12) Patent Application Publication
(10) Pub. No.: US 2010/0220278 A1
(43) Pub. Date: Sep. 2, 2010

(54) Method of manufacturing liquid crystal display device and liquid crystal display device fabricated by the same

(75) Inventor: Tomoko Maruyama, Kanagawa (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 12/660,010

(22) Filed: Feb. 18, 2010

(30) Foreign Application Priority Data
Feb. 27, 2009 (JP) P2009-045941

(51) Int. Cl. G02F 1/1339; H01J 9/26

(52) U.S. Cl. 349/153; 445/25

(57) ABSTRACT

A method of manufacturing a liquid crystal display device includes the steps of: forming a seal layer on one of a pair of substrates having a display region at a position opposed to each other and having a surrounding region around the display region, in which the seal layer is formed to have substantially a frame configuration in the surrounding region of one of the pair of substrates and configured of a thermosetting resin; dropping a liquid crystal within the frame configuration of the seal layer; forming a liquid crystal layer between the pair of substrates by superposing the pair of substrates under reduced pressure and by releasing the pressure thereafter; and thermally curing the seal layer after forming the liquid crystal layer.

### CROSS-REFERENCE TO RELATED APPLICATION

The present application claims priority from Japanese Patent Application No. JP JP 2009-045941 filed in the Japanese Patent Office on Feb. 27, 2009, the entire content of which is incorporated herein by reference.

### BACKGROUND OF THE INVENTION

1. Field of the Invention

The present invention relates to a method of manufacturing a liquid crystal display device utilizing a liquid crystal dropping method, and to a liquid crystal display device fabricated by the same.

2. Description of the Related Art

A liquid crystal display (hereinafter may be referred to as “LCD”) device is provided with a liquid crystal layer between a driving substrate and a counter substrate. The driving substrate (or a TFT substrate) includes a TFT (Thin-Film Transistor) element layer, a pixel electrode layer, a flattening layer, and an alignment film. The counter substrate includes a BM (Black Matrix) layer, a CF (Color Filter) layer, a common electrode, and an alignment film. Also, a seal layer is provided between the driving substrate and the counter substrate to attach the driving substrate and the counter substrate together, and to prevent leakage of liquid crystal.

As a method for forming the liquid crystal layer between the driving substrate (or a pixel substrate) and the counter substrate in the liquid crystal display device having such a structure described above, a vacuum injection method, which injects the liquid crystal after the pixel substrate and the counter substrate are attached together, has been used. However, the vacuum injection method has a problem in that the productivity is inferior when the area of a substrate is enlarged, since it takes a long time to inject the liquid crystal.

To address this problem, a method called an “one-drop fill (hereinafter may be referred to as “ODF”)” method has been developed. The ODF method drops a liquid crystal material on one of two substrates before the two substrates are attached together to be sealed. In the ODF method, an UV (ultraviolet) curing sealant or a photo-thermo-combined curing sealant (hereinafter may be simply referred to as a “combined sealant”) is used as a material (or a sealant) structuring the seal layer, as disclosed in Japanese Patent Unexamined Publication No. 2004-62138 for example. The ODF method enables mass-production, and also requires no injection opening for performing instillation of the liquid crystal in medium-sized and small-sized LCDs. This makes it possible to eliminate a thickness of a substrate for sealing the injection opening, and thus to achieve low-profiling.

### SUMMARY OF THE INVENTION

Currently, development of a display, which is light in weight and high in visibility, has been conducted in medium-sized and small-sized LCDs, and studies on technologies for further narrowing a frame size of a surrounding region (i.e., light-shielding part around an active area) in which a BM layer is formed, and for further attaining the low-profiling of a panel, have been in progress. However, a region (or an opening) for ultraviolet radiation on the surrounding region is necessary when the above-described UV curing sealant or the combined sealant is used. In other words, the panel has to be designed in consideration of the addition of the UV radiation region to the surrounding region, which has been a factor for hampering the narrowing of the frame size.

It is desirable to provide a method of manufacturing a liquid crystal display device capable of mass-production with the use of a liquid crystal dropping method and of narrowing a frame size of a panel, and a liquid crystal display device fabricated by the same.

A method of manufacturing a liquid crystal display device according to an embodiment of the invention includes the steps of: forming a seal layer on one of a pair of substrates having a display region at a position opposed to each other and having a surrounding region around the display region, the seal layer being formed to have substantially a frame configuration in the surrounding region of one of the pair of substrates, and being configured of a thermosetting resin; dropping a liquid crystal within the frame configuration of the seal layer; forming a liquid crystal layer between the pair of substrates by superposing the pair of substrates under reduced pressure and by releasing the pressure thereafter; and thermally curing the seal layer after forming the liquid crystal layer.

A liquid crystal display device according to an embodiment of the invention includes: a pair of substrates having a display region at a position opposed to each other and having a surrounding region around the display region; a liquid crystal layer held between the pair of substrates; and a seal layer sealing the liquid crystal layer in the surrounding region of the pair of substrates, and configured of a thermosetting resin.

In the liquid crystal display device and the method of manufacturing the liquid crystal display device according to the embodiments of the invention, the thermosetting resin is used as a sealant for sealing the liquid crystal layer, and the sealant is cured by thermal curing to form the seal layer.

According to the method of manufacturing the liquid crystal display device of the embodiment of the invention, the seal layer configured of the thermosetting resin is formed substantially in the frame configuration on one of the pair of substrates, and the liquid crystal is dropped within the frame configuration of the seal layer. Then, the substrates are superposed, and the seal layer is thereafter subjected to the thermal curing. This makes it possible to manufacture the liquid crystal display device in which an opening structure for curing the sealant is eliminated. Thus, a degree of freedom in panel designing increases as compared with a case where a photo-curing sealant or a combined sealant is used. Therefore, it is possible to achieve narrowing of a frame size.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the specification, serve to explain the principles of the invention.

FIG. 1 is a cross-sectional view illustrating a configuration of a liquid crystal display device according to an embodiment of the invention.

FIG. 2 is a plan view illustrating an overall configuration of a liquid crystal display panel.

FIG. 3 is a plan view illustrating a configuration of a TFT substrate of the liquid crystal display panel.

FIG. 4 is a plan view illustrating a configuration of a counter substrate of the liquid crystal display panel.

FIG. 5 is an exploded perspective view illustrating a pixel region of the liquid crystal display panel.

FIG. 6 is a process flow chart explaining a liquid crystal dropping method.

FIG. 7 illustrates a process of drawing a seal.

FIG. 8 illustrates a process of dropping liquid crystal.

FIG. 9 illustrates a process of rough alignment of the substrates.

FIG. 10 illustrates a process of superposing the substrates.

FIG. 11 illustrates a process of dividing the substrates.

FIG. 12 explains a method of semi-curing a seal layer.

FIG. 13 explains another method of semi-curing the seal layer.

### DETAILED DESCRIPTION OF THE PREFERRED EMBODIMENTS

Hereinafter, an embodiment of the present invention will be described in detail with reference to the accompanying drawings. The description will be given in the following order.

Embodiment

(1) Overall Configuration of Liquid Crystal Display Device

(2) Manufacturing Method of Liquid Crystal Display Device

### [Embodiment]

In the following, description will be made on one embodiment of the present invention where a liquid crystal display device is based on a transmissive-type display panel. It is to be appreciated that the embodiment of the invention is not limited thereto, and is applicable to a reflective type, a semi-transmissive type, or other suitable type as well.

### [Overall Configuration of Liquid Crystal Display Device]

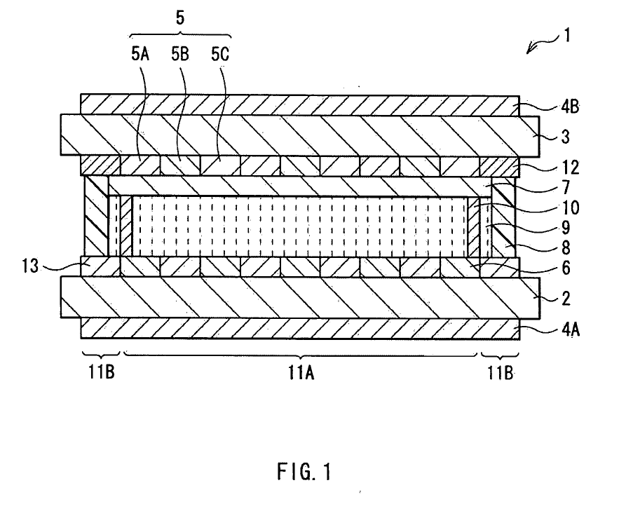

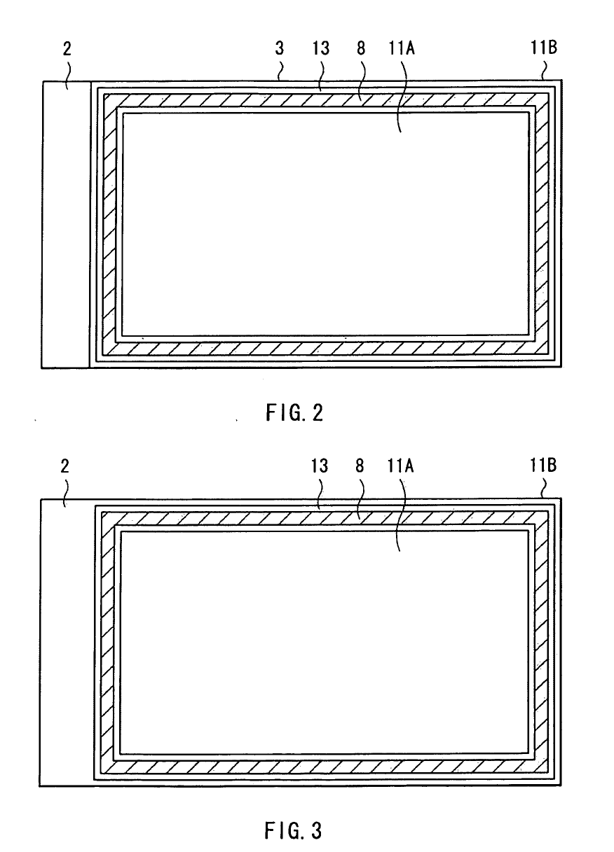

FIG. 1 illustrates a cross-sectional configuration of a transmissive liquid crystal display panel (or a liquid crystal display device) 1 according to the embodiment of the present invention. FIG. 2 illustrates a plan configuration of the entire panel. The liquid crystal display panel 1 is provided with a liquid crystal layer 9 sealed by a seal layer 8 between a TFT substrate (or a driving substrate) 2 and a counter substrate 3.

Each of the TFT substrate 2 and the counter substrate 3 has a display region (or a pixel region) 11A at a position where the TFT substrate 2 and the counter substrate 3 are opposed to each other. A region surrounding the display region 11A is a surrounding region 11B. The seal layer 8 is provided in the surrounding region 11B, and seals the liquid crystal layer 9 provided in the display region 11A.

The TFT substrate 2 can be a glass substrate disposed with a plurality of pixel electrodes 6 arranged in a matrix pattern on the glass substrate, for example. The TFT substrate 2 is further provided with TFT elements for driving the respective pixel electrodes 6, gate lines and source lines connected to the TFT elements, and so on (each of which is not illustrated), which are disposed on the TFT substrate 2. The pixel electrode 6 is formed with an electrically-conductive material having transparency, and is provided for each sub-pixel (unillustrated) on the glass substrate for example. The conductive material can be ITO (Indium Tin Oxide), or other suitable material.

FIG. 3 illustrates a plan configuration of the TFT substrate 2. The surrounding region 11B of the TFT substrate 2 is provided with a wiring layer 13 for driving pixels in the display region 11A, and the seal layer 8 is provided on the wiring layer 13. A line-width of the wiring layer 13 can be between about 200 μm and 1200 μm both inclusive.

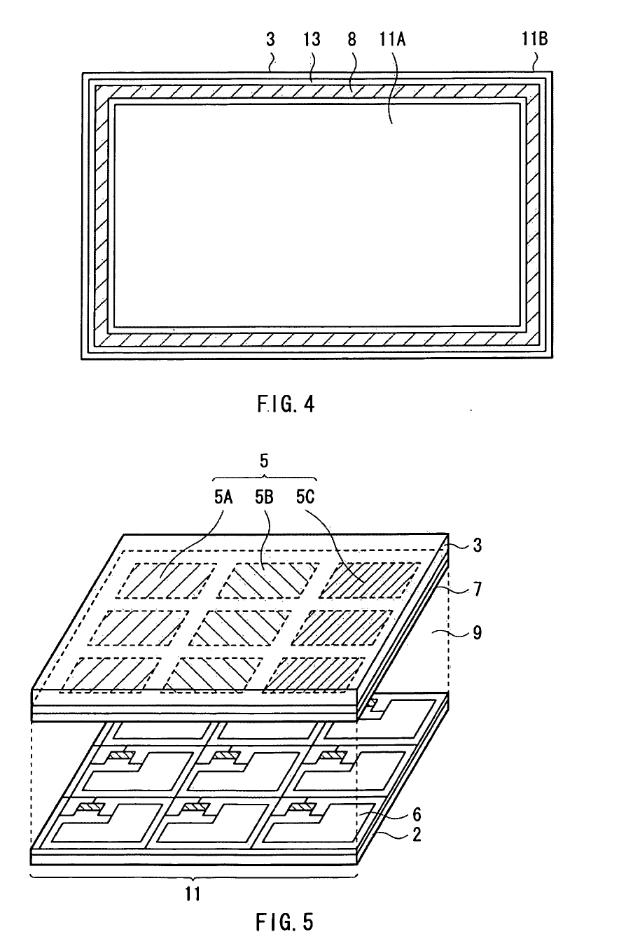

FIG. 4 illustrates a plan configuration of the counter substrate 3. The counter substrate 3 can be a glass substrate having: a color filter 5 disposed thereon in which a red (R) filter, a green (G) filter, and a blue (B) filter (color filters 5A to 5C, respectively) are provided in a stripe configuration; and a counter electrode 7 disposed substantially throughout an entire effective display region on the color filter 5, for example. The counter electrode 7 is formed with an electrically-conductive material having transparency, which can be ITO (Indium Tin Oxide), or other suitable material. A spacer 10 is formed between the counter electrode 7 and the pixel electrode 6 located on the TFT substrate 2 side, for keeping a gap distance between the TFT substrate 2 and the counter substrate 3. The spacer 10 can be a photosensitive negative resin.

The surrounding region 11B which surrounds the color filter 5 of the counter substrate 3 is provided with a light-shielding film 12 (a frame or a black matrix). The seal layer 8 is provided between the light-shielding film 12 and the wiring layer 13 located on the TFT substrate 2 side.

A back surface of the TFT substrate 2 is disposed with a polarizing plate 4A, and an upper surface of the counter substrate 3 is disposed with a polarizing plate 4B. Each of the polarizing plate 4A and the polarizing plate 4B transmits therethrough polarized light vibrating in a particular direction.

In one embodiment where the liquid crystal panel is of a vertical alignment type, the liquid crystal layer 9 includes: liquid crystal molecules having negative dielectric anisotropy; and a polymer structure which retains the liquid crystal molecules in the vicinity of interfaces between the polymer structure and alignment films (not illustrated). The liquid crystal molecule has a property that a dielectric constant in a long-axis direction thereof is higher than that in a short-axis direction thereof. Thus, the liquid crystal molecules are caused to be aligned such that the long-axes of the liquid crystal molecules become perpendicular to the substrates when a driving voltage is off, and are caused to be aligned such that the long-axes of the liquid crystal molecules become parallel to the substrates when the driving voltage is turned on, by utilizing that property. Thereby, an image is displayed on the liquid crystal display panel.

FIG. 5 illustrates perspective configurations of the TFT substrate 2 and the counter substrate 3 in the liquid crystal display panel 1. It can be seen from FIG. 5 that the pixel electrode 6 is formed for each of the pixels in the TFT substrate 2. Also, the pixels in the counter substrate 3 are disposed with the corresponding color filters 5A to 5C of red (R), green (G), and blue (B), respectively.

In the present embodiment, the seal layer 8 is structured by a sealant made of a thermosetting resin (or a thermosetting sealant 8a). The sealant can be an epoxy resin, a urea resin, a melamine resin, a phenol resin, an unsaturated polyester resin, an alkyd resin, a urethane resin, or any other suitable material.

In the liquid crystal display panel 1 according to the present embodiment having the configuration described above, the liquid crystal layer 9 is driven when predetermined voltages are applied to the pixel electrodes 6 and the counter electrodes 7 respectively, and thereby the image is displayed.

### [Manufacturing Method of Liquid Crystal Display Device]

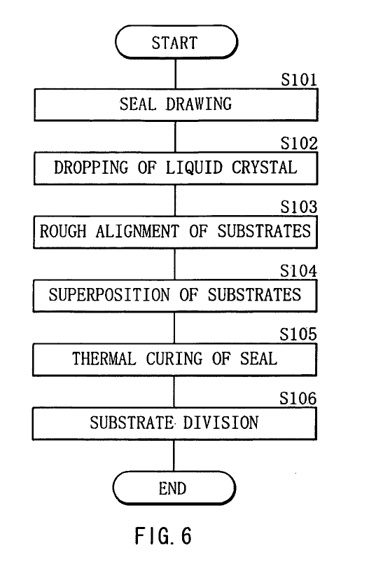

Now, a method of manufacturing the liquid crystal display panel 1 according to the present embodiment will be described with reference to a process flow chart illustrated in FIG. 6 and FIG. 7 to FIG. 11.

First, members used for forming the liquid crystal display panel 1 are formed on a transparent substrate made of a glass for example. Specifically, two transparent substrates are prepared. Then, TFTs, drain bus lines, gate bus lines (each of which is not illustrated), the pixel electrodes 6, and so forth are formed on one of the transparent substrate, followed by formation of the alignment film (not illustrated) thereon, to obtain a TFT large substrate 14 (i.e., the TFT substrate 2). On the other hand, the color filters 5 including the color filters 5A to 5C of red (R), green (G), and blue (B), and the counter electrodes 7 made of ITO films for example are formed on the other transparent substrate at predetermined positions, followed by formation of the alignment film (not illustrated) thereon and formation of the light-shielding film 12 therearound, to obtain a counter large substrate 15 (i.e., the counter substrate 3).

After forming the TFT large substrate 14 and the counter large substrate 15, the liquid crystal display panel 1 is fabricated in accordance with the process flow of a liquid crystal dropping method illustrated in FIG. 6. The large substrate subjected to a seal drawing may be either the TFT large substrate 14 or the counter large substrate 15. In the following, description will be made on the basis of one embodiment where the thermosetting sealant 8a is applied to the counter large substrate 15. In one embodiment, the seal drawing utilizing the thermosetting sealant 8a is so performed on the counter large substrate 15 as to surround the display region 11A first (step S101). Then, a predetermined amount of liquid crystal is dropped in a thus-formed frame-like configuration of the counter large substrate 15 (step S102). Then, the TFT large substrate 14 and the counter large substrate 15 are placed in an attaching system to perform rough alignment of the TFT large substrate 14 and the counter large substrate 15 (step S103), followed by superposition of the TFT large substrate 14 and the counter large substrate 15 (step S104). Then, thermal curing of the thermosetting sealant 8a is implemented in accordance with curing conditions of the thermosetting sealant 8a (step S105). Then, a substrate as the superposed and cured large substrates is divided into each panel size (step S105). Thereby, the liquid crystal display panel 1 is completed. Hereinafter, each process will be described in detail.

### [1. Seal Drawing]

FIG. 7 illustrates a process of drawing the thermosetting sealant 8a on the counter large substrate 15. The thermosetting sealant 8a is so applied, for each panel, on a surface of the counter large substrate 15 as to surround the display region 11A sealing the liquid crystal. The thermosetting sealant 8a is applied on the light-shielding film 12 provided in the counter large substrate 15 with an amount of the thermosetting sealant 8a, dispensed from a seal dispenser 16, corresponding to a line-width of the seal and to the gap distance of the liquid crystal layer 9. At this time, it is preferable, on as needed basis, that the thus-applied thermosetting sealant 8a (an inner circumferential part thereof in particular), which is uncured yet, be heated with a hot plate 20 or with other suitable member under the condition of about 60 degrees Celsius for two minutes for example, to preliminary perform semi-curing of the thermosetting sealant 8a.

FIG. 12 illustrates one example of a method of the semi-curing utilizing the hot plate 20. In one embodiment, a heating part 20a having a frame-like configuration is previously provided at a position corresponding to the inner circumferential part of the thermosetting sealant 8a which is applied in the frame-like configuration on the counter large substrate 15. Then, the counter large substrate 15 is brought closer or lowered to the vicinity of the hot plate 20 to heat the inner circumference of the thermosetting sealant 8a for each panel with the heating part 20a, so as to semi-cure the thermosetting sealant 8a. Note that the positional relationship between the hot plate 20 and the counter large substrate 15 may be reversed as illustrated in FIG. 12, in accordance with one embodiment of the invention.

### [2. Dropping of Liquid Crystal]

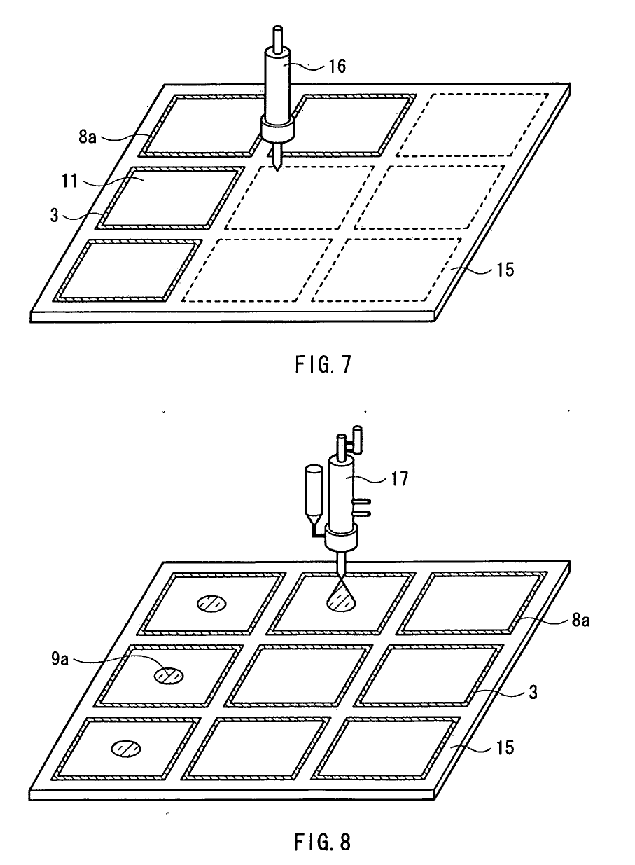

FIG. 8 illustrates a process of dropping liquid crystal on the counter large substrate 15. Liquid crystal 9a is dropped from a liquid crystal dispenser 17 onto the counter large substrate 15 in a region thereof to which the thermosetting sealant 8a is applied. In other words, the liquid crystal 9a is dropped for each counter substrate 3 (or per panel). The liquid crystal 9a may be dropped on one part within the frame-like configuration, or may be dropped onto a plurality of parts within the frame-like configuration.

### [3. Rough Alignment of Substrates]

FIG. 9 illustrates a process of rough alignment of the TFT large substrate 14 and the counter large substrate 15. The counter large substrate 15 onto which the liquid crystals 9a are dropped is placed on a stage within the attaching system (not illustrated). The TFT large substrate 14 is also brought into the attaching system and is retained by a supporting member provided therein. Then, an exhaust valve of the attaching system is opened to perform vacuum evacuation through an exhaust port, such that the pressure in a processing chamber within the system is reduced to have a decompressed state. Then, the TFT large substrate 14 and the counter large substrate 15 are disposed to oppose each other, and are pressurized weakly to perform the rough alignment.

### [4. Superposition of Substrates]

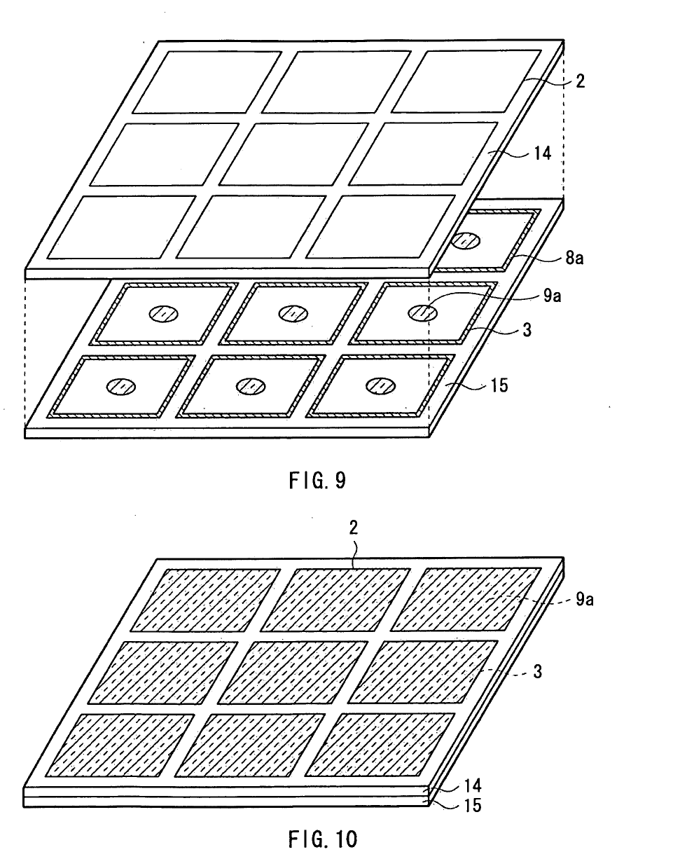

FIG. 10 illustrates a process of superposing the TFT large substrate 14 and the counter large substrate 15 precisely. The TFT large substrate 14 and the counter large substrate 15, to which the rough alignment is performed, are taken out from the system to the atmosphere, and are so subjected to precise position-alignment that the pixel regions 11A of the TFT large substrate 14 and the counter large substrate 15 are opposed to each other respectively. This process causes the dropped liquid crystals 9a to spread substantially throughout the regions surrounded by the thermosetting sealants 8a so as to establish the liquid crystal layers 9, respectively.

### [5. Thermal Curing of Seal]

The above process causes the liquid crystal 9a to be sealed by the thermosetting sealant 8a between a gap between the TFT substrate 2 (for one panel) and the counter substrate (for one panel). A heat treatment is thereafter performed under the condition by which the thermosetting sealant 8a cures sufficiently, such as about 130 degrees Celsius for two hours although it is not limited thereto, to form the seal layer 8.

### [6. Substrate Division]

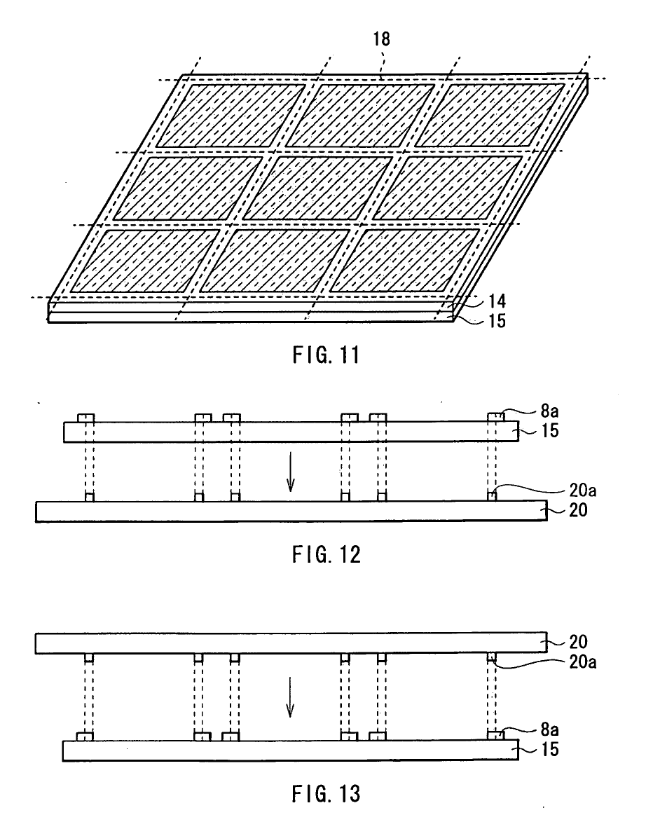

FIG. 11 illustrates a process of dividing the large substrates into each panel. A substrate as the attached TFT large substrate 14 and the counter large substrate 15 is divided or cut along scribe lines 18 into each panel size.

According to the method of manufacturing the liquid crystal display device of the present embodiment of the invention, the liquid crystal layer 9 between the TFT substrate 2 and the counter substrate 3 is sealed by the seal layer 8 configured of the thermosetting resin. Thus, an opening structure for curing a sealant is eliminated, i.e., there is no need for providing an opening for ultraviolet transmission provided in existing cases where a photo-curing sealant or a combined sealant is used. This makes it possible to fabricate a liquid crystal panel having high degree of freedom in panel designing. Therefore, it is possible to achieve narrowing of a frame size of a panel. Also, the process for semi-curing the uncured thermosetting sealant 8a may be added after the drawing of the thermosetting sealant 8a to the substrate is performed. This makes it possible to suppress elution of components of the seal into the display region 11A. Therefore, it is possible to increase the reliability of liquid crystal panel.

Although the present invention has been described in the foregoing by way of example with reference to the embodiment, the present invention is not limited thereto but may be variously modified. For example, the description has been made on the embodiment where the liquid crystal display panel is directed to medium-sized and small-sized direct-view liquid crystal display devices, but the present invention is also applicable to a liquid crystal display panel for a large-sized direct-view liquid crystal display device. Further, the present invention is applicable similarly to a liquid crystal display device in a projection liquid crystal projector, or any other suitable device.

Although the present invention has been described in terms of exemplary embodiments, it is not limited thereto. It should be appreciated that variations may be made in the described embodiments by persons skilled in the art without departing from the scope of the present invention as defined by the following claims. The limitations in the claims are to be interpreted broadly based on the language employed in the claims and not limited to examples described in the present specification or during the prosecution of the application, and the examples are to be construed as non-exclusive. For example, in the present disclosure, the term “preferably”, “preferred” or the like is non-exclusive and means “preferably”, but not limited to. The use of the terms first, second, etc. do not denote any order or importance, but rather the terms first, second, etc. are used to distinguish one element from another. Moreover, no element or component in the present disclosure is intended to be dedicated to the public regardless of whether the element or component is explicitly recited in the following claims.

What is claimed is:

1. A method of manufacturing a liquid crystal display device, comprising the steps of:
forming a seal layer on one of a pair of substrates having a display region at a position opposed to each other and having a surrounding region around the display region, the seal layer being formed to have substantially a frame configuration in the surrounding region of one of the pair of substrates, and being configured of a thermosetting resin;
dropping a liquid crystal within the frame configuration of the seal layer;
forming a liquid crystal layer between the pair of substrates by superposing the pair of substrates under reduced pressure and by releasing the pressure thereafter; and
thermally curing the seal layer after forming the liquid crystal layer.

2. The method of manufacturing the liquid crystal display device according to claim 1, further comprising the step of semi-curing the seal layer by previously heating the seal layer, after forming the seal layer configured of the thermosetting resin on one of the pair of substrates and before the pair of substrates are superposed.

3. The method of manufacturing the liquid crystal display device according to claim 2, wherein an inner circumferential part of the seal layer is semi-cured.

4. The method of manufacturing the liquid crystal display device according to claim 1, wherein one of the pair of substrates formed with the seal layer has a wiring in the surrounding region, and the seal layer is formed on the wiring.

5. A liquid crystal display device, comprising:
a pair of substrates having a display region at a position opposed to each other and having a surrounding region around the display region;
a liquid crystal layer held between the pair of substrates; and
a seal layer sealing the liquid crystal layer in the surrounding region of the pair of substrates, and configured of a thermosetting resin.

6. The liquid crystal display device according to claim 5, further comprising a light-shielding film provided on one or both of the pair of substrates and overlapped with the seal layer in a direction to which the pair of substrates are opposed.

7. The liquid crystal display device according to claim 5, further comprising a wiring provided in the surrounding region of one or both of the pair of substrates and on which the seal layer is formed, the wiring having a line-width of between substantially 200 μm and substantially 1200 μm both inclusive.
